(19) United States
(12) Patent Application Publication
(10) Pub. No.: US 2010/0082291 A1
(43) Pub. Date: Apr. 1, 2010

(54) Monitoring All-Optical Network Performance

(76) Inventors: Yonggang Wen, Santa Clara, CA (US); Kevin W. Wilson, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/239,072

(22) Filed: Sep. 26, 2008

(51) Int. Cl. G06F 11/30; G06F 15/00; H04B 10/08

(52) U.S. Cl. 702/180; 702/186; 398/25

(57) ABSTRACT

A method monitors a performance of an all-optical network by acquiring data from the network in a form of histograms. A dimensionality of the histograms is reduced by fitting Gaussian mixture models to the histograms to produce corresponding 4-dimensional quadruples (μ₀,μ₁,σ₀,σ₁), wherein μᵢ is a mean, and σᵢ, is a standard deviation of each Gaussian mixture model for zero and one bits as indicated in the subscripts i. Regression analysis is applied to features extracted the 4-dimensional quadruples to determine a noise level and a chromatic dispersion level of the all-optical network.

### FIELD OF THE INVENTION

This invention relates generally to optical networks, and more particularly to measuring the performance of all-optical networks.

### BACKGROUND OF THE INVENTION

Optical Networks

For an all-optical network, it is necessary to monitor the performance of the network. Compared with conventional synchronous optical networks (SONET), all-optical networks do not use optical-to-electrical (OE) conversions at intermediate nodes. Instead, all components, such as switches and routers, are optical components.

As a result, the conventional parity check approach in the electrical domain at the intermediate nodes to assess the performance would become extremely costly and cumbersome if optical signals were tapped-out for performance monitoring.

Performance Monitoring

Known methods for optical performance monitoring (OPM) can include wavelength-division multiplexing (WDM) channel monitoring, channel quality monitoring, and protocol monitoring. In its simplest form, OPM records a power level of each individual wavelength channel in the WDM network. In a more advanced version, OPM measures a bit-error-rate (BER) of each wavelength channel. In between, OPM can provide a quantitative assessment of signal impairments, such as chromatic dispersion (CD), polarization-mode dispersion (FMD), four-wave mixing (FWM), and other detrimental nonlinearities.

Optical performance monitoring, when deployed, can enable configuration, management, performance management and fault management in all-optical networks that accommodate dynamic services. Indeed, potential applications for OPM include: use as part of a feedback loop to keep operating in an optimal manner; use as a tool for fault localization in the event of a network failure; use as a prognostic tool that predicts network failures and allows traffic to be rerouted before failure occurs.

Performance monitoring can be model-based or data-driven. The model-based approach uses a network model and feature extraction. The model-based approach relies on an accurate network model. Specifically, the model-based approach first constructs an accurate and workable model of the optical network, on the basis of the functional and physical properties of the network components, and performs diagnosis by comparing actual observations, i.e., extracted features, with forecasts from the model. As an advantage, the model-based approach can detect unanticipated faults. Data-driven performance monitoring is described below.

### SUMMARY OF THE INVENTION

The embodiments of the invention provide a method for monitoring a performance of an all-optical network, where ail components internal to the network are optical components. The method, uses a data-driven approach for optical performance monitoring. That is, the method applies statistical methods to estimate optical transmission impairments, e.g., noise and chromatic dispersion, from histograms.

Different impairments result in different values for features extracted from histograms. A number of regression analysis procedures can be used to estimate the noise and chromatic dispersion, and compare the accuracy of their estimates. Linear regression provides a reasonable accuracy for the estimate, and a locally weighted regression, technique performs better.

### BRIEF DESCRIPTION OF THE DRAWINGS

FIG. 1 is a flow diagram of a method for monitoring the performance of an optical network according to embodiments of the invention;

FIG. 2 is a block diagram of an optical network according to embodiments of the network;

FIGS. 3A and 3B are performance histograms acquired by embodiments of the invention form an optical network;

FIGS. 4A and 4B are visualizations of features related to noise and chromatic dispersion according to embodiments of the invention;

FIGS. 5A-5C are visualizations of estimation errors for noise attenuation according to embodiment of the invention; and

FIGS. 6A-6C are visualizations of estimation errors for chromatic dispersion according to embodiment of the invention.

### DETAILED DESCRIPTION OF THE PREFERRED EMBODIMENTS

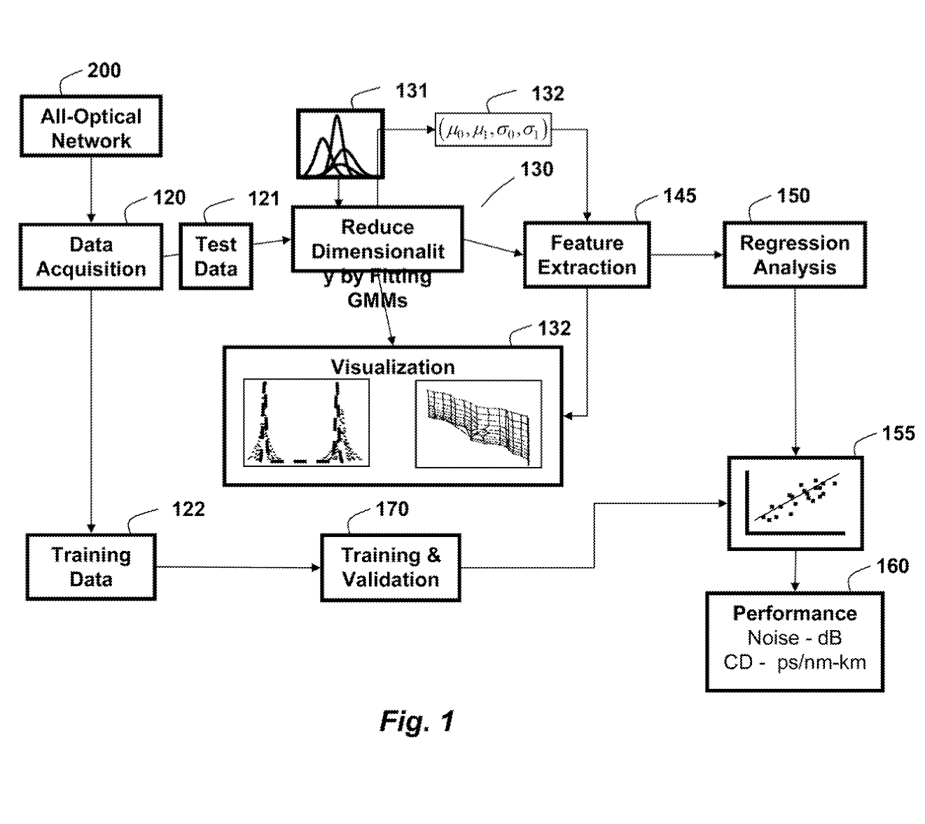

As shown in FIG. 1, the embodiments of our invention provide a method for monitoring a performance 160 of an all-optical network 200. The method is data-driven and operates on features extracted from optical signals in the network. Performance impairments include noise and chromatic dispersion (CD). CD is the phenomenon in which the phase velocity of an optical signal depends on its frequency. Information about these impairments can be used to assess a quality of the optical signal, and facilitate suppression of the impairments.

Our data-driven method uses two data sets. Labeled training data 122 implicitly specify a hidden relationship between the training data and a known state of the network. Testing data 121 are used to estimate an unknown state of the network. The testing data 121 are acquired 120 from the optical network 200, and features are extracted 145. The performance measurement 160 is based on the extracted features.

Passive Monitoring

In passive monitoring, information is extracted from the optical signals. The information is in the form of histograms, which can be synchronous or asynchronous. If the sampling rate is equal to the bit rat, and the samples are acquired at the decision instant, i.e., in the centre of each bit, then the histogram is synchronous. The synchronous histograms focus on the region of the signal that the receiver uses to determine the received bit sequence. If the sampling rate is based on a Poisson noise process, then the histogram is asynchronous, and the samples are across an entire bit period. Asynchronous sampling does not require clock extraction, and can be done at less than the bit rate. We focus on the synchronous histogram, because the histogram is most directly related to the performance, i.e., the bit-error-rate.

Data Processing

The extracted information is processed to reduce its dimensionality by fitting 130 Gaussian mixture models (GMMs) 131 to the histograms. This is followed by feature extraction 145 and statistical inference in the form of regression analysis 150.

The pre-processing reduces the dimensionality of the data by fitting 130 the GMMs to the histogram data. This facilitates the estimation of the different performance parameters 160. The statistical inference infers the impairments 160 using a regression function 155 learned from the training data 122.

We investigate how different levels of noise and chromatic dispersion changes synchronous histograms in our data-driven performance monitoring method.

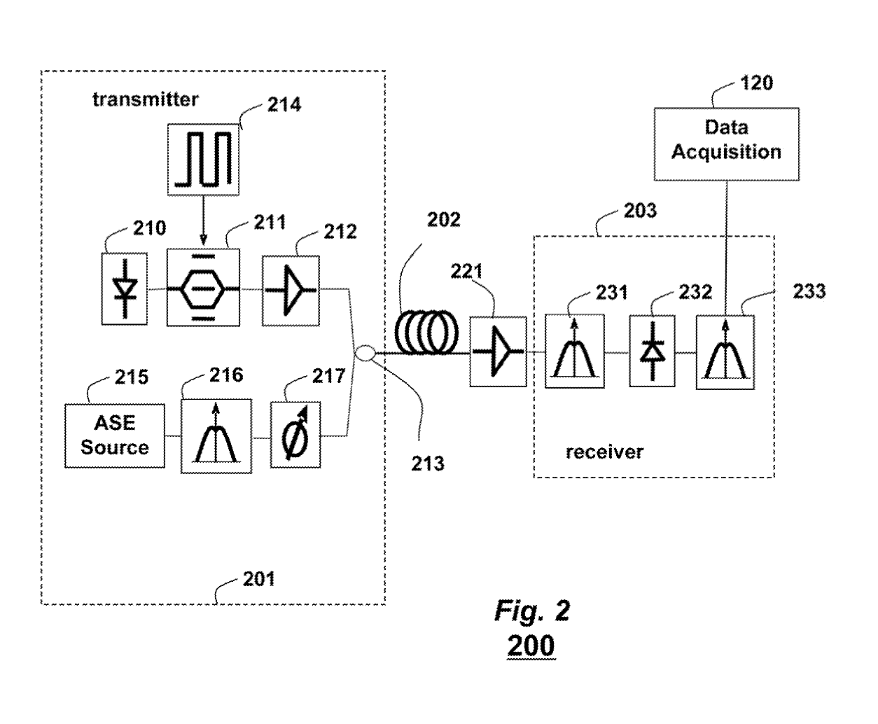

FIG. 2 shows our optical network 200 including a transmitter 201, an optical link 202, and a receiver 203. An output of the receiver is the acquired data.

The transmitter 201 generates two optical signals. A light source 210 generates an optical signal with a center frequency of 193.1 THz. The signal is modulated 211 with a 10 Gbps return-to-zero (RZ) signal 214 for data transmission, and pre-amplified 212.

An amplified spontaneous emission (ASE) source 215 generates noise. A spectrum intensity of the ASE source is 5 dBm/THz. The noise is bandpass filtered (BPF) 216. We can vary 217 an attenuation coefficient, i.e., a, in a range of 10 dB to 20 dB to induce different noise levels. The data signal and the noise are mixed 213 and inserted into the optical link 202.

The optical link includes 50 km of single mode liber (SMF) 221, and in-line optical amplifiers 221 as needed. The output power of the amplifiers is set at 6 dBm. During training, we can sweep the chromatic dispersion coefficient I) of the SMF fiber in the range of 5 to 20 ps/nm-km to induce different levels of chromatic dispersion, while turning off all other non-linearities.

The receiver 203 includes an optical bandpass filter 231, a photodetector 232, and an electrical bandpass filter 233.

Pre-processing for Gaussians Mixture Models (GMM)

We acquire 120 a set of synchronous histograms under different noise attenuation levels and CD levels from optical signals in the network. The dimensionality of the data in the histograms, i.e., the number of bins in the histogram, can be high. For example in practical networks, the number of bins could reach a few thousand. Therefore, we first reduce 130 the dimensionality of the histogram data, while extracting as much information as possible.

Our dimensionality reduction of the histograms is based on a Gaussian mixture models (GMM). If on-off-keying (OOK) is used, then the histograms can be modeled accurately with GMMs with two components, i.e., one center for ZERO bits, and the other center for ONE bits in the optical signal.

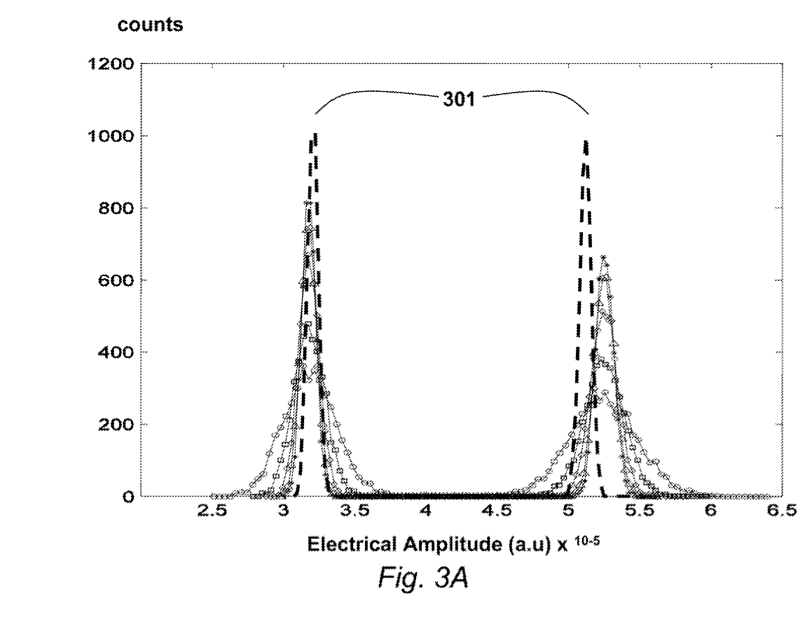

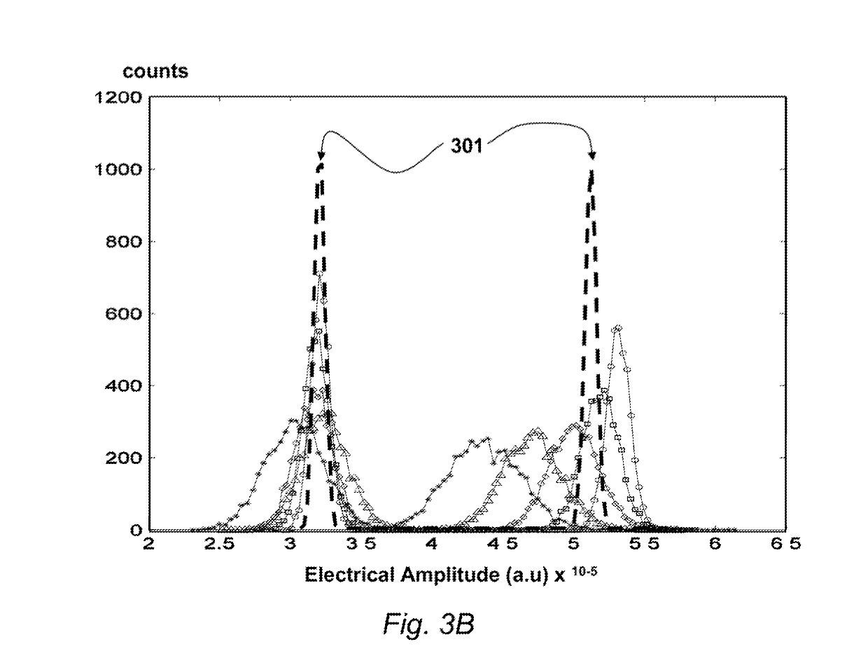

FIGS. 3A-3B show example histograms. In these Figures, the vertical axis is counts, and the horizontal axis electrical amplitude. The two histograms with the dashed peaks are for benchmark data. The other histograms are for simulated data. FIG. 3A shows different noise attenuation values for a given fiber chromatic dispersion coefficient. FIG. 36 shows results for different fiber chromatic dispersion coefficients for a given noise attenuation.

With our GMMs, the parameters are quadruples (μ₀,μ₁,σ₀,σ₁) 132, where μᵢ corresponds to the mean, and σᵢ corresponds to the standard deviation of the zero and one hits as indicated in the subscripts, respectively.

We can use a maximum likelihood (ML) procedure to determine the parameters of different probability distributions functions (PDF), i.e., our GMMs. We use an expectation maximization (EM) procedure to find the parameters of our two-component GMM. The EM procedure is guaranteed to converge to at least a local maximum of the likelihood function. The EM procedure alternates between estimating which of the data samples belong to each of the two mixture components and estimating the parameters, i.e., the mean and standard deviation, of these two mixture components from the data samples assigned to each component.

In addition, we obtain data from a transmission network with no noise and no chromatic dispersion and estimate its center and standard deviation as the benchmark distributions 301. In practical, networks, the benchmark data can be obtained from a calibration phase of the network design, or from a simulation testbed of the network. We suppress the effect of specific network configuration by normalizing our data over the benchmark data. A normalized quadruple is then used as an input to the feature extraction 145 described in greater detail below.

Feature Extraction

There are two embodiments for the feature extraction. One is based on a physical network model and the other is based on a statistical framework, e.g., principal components analysis (PCA). We use a 2-dimensional projection 155 of our 4-dimensional GMMs parameterization to characterize the network performance 160.

Both sets of features, i.e., for noise levels and chromatic dispersion levels, are located in distinct regions of the feature space. Thus, we should be able to predict the noise attenuation and the chromatic dispersion from our observed features. The features include the mean and the standard deviation of the bits as represented in the histograms.

Physical Model

FIGS. 3A-3B show the usefulness of our features by comparing histograms with different noise attenuation labels and chromatic dispersion labels. As shown in FIG. 3A for a given noise attenuation label, e.g., 5 dB, the mean and standard deviation for bit ONE shifts increase as the fiber chromatic dispersion increases. This is because chromatic dispersion only distorts the optical pulse for bit ONE.

As shown in FIG. 3B for a given fiber chromatic dispersion label, e.g., 2 ps/nm-km, the standard deviations for both bit ZERO and bit ONE increases as the noise attenuation label increases. Notice that the standard deviations for both bit ONE and bit ZERO change concurrently and are highly correlated. Therefore, we expect reasonable results, even when ignoring one of the two standard deviations.

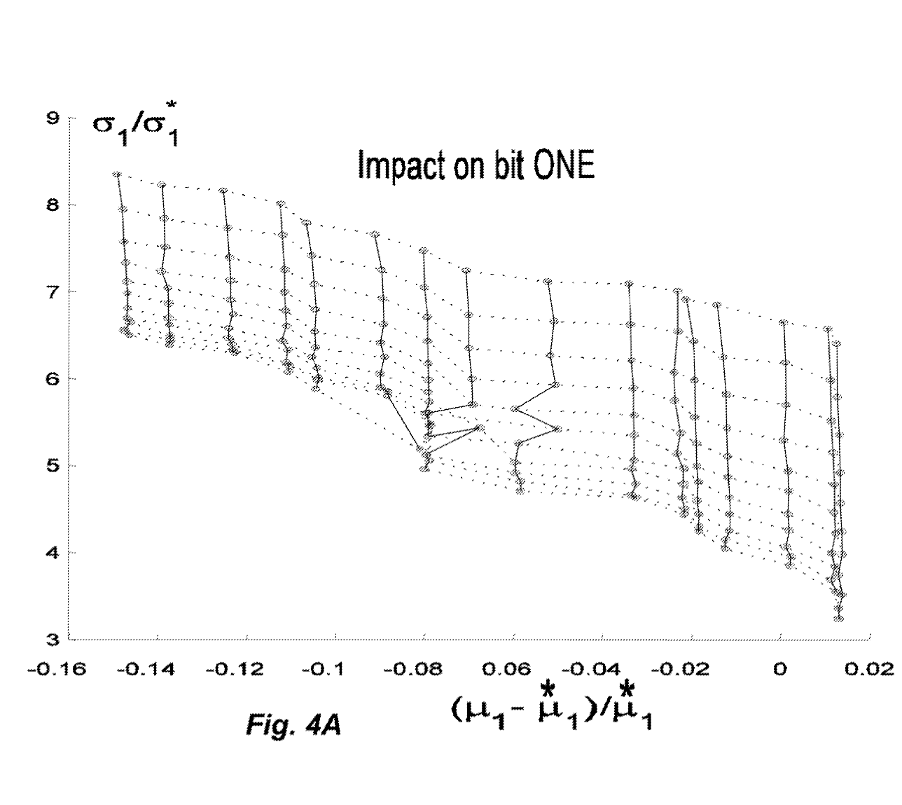

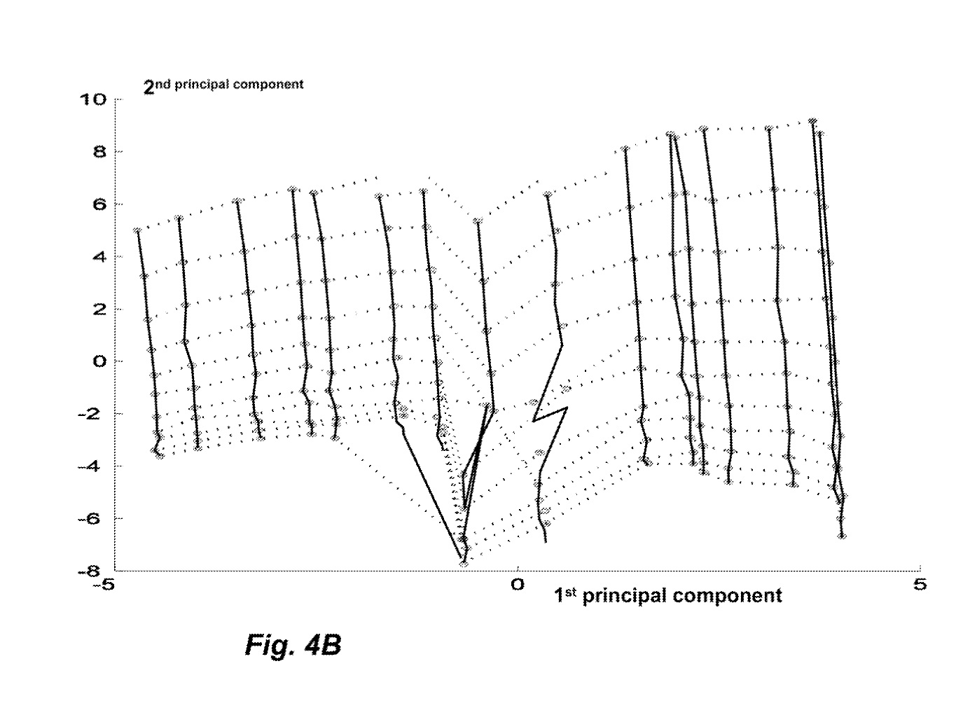

Using this set of 2-D features, we can visualize the separation between the noise attenuation label and the chromatic dispersion label as shown in FIG. 4A, where different points correspond to different simulation settings, in FIG. 4A, the vertical axis is a ratio of the means, and the horizontal axis a ratio of the standard deviations. The noise attenuation is in the range of 10-20 dB, and the chromatic dispersion is the range of 5-20 ps/nm-km. The mostly horizontal dotted lines join points of constant noise attenuation, while the mostly vertical solid lines join points of constant chromatic dispersion. As long as distinct noise attenuation and CD values map to distinct locations in the feature space, as they always do, we can invert the relationship to estimate noise attenuation and CD from our observed features.

Principal Components Analysis

As shown in FIG. 4B, the second set of features includes the first two components generated from principle components analysis (PCA) over the four parameters of the 4-D GMMs. In FIG. 4B, the horizontal axis is the first principal component, and the vertical axis the second principal component.

Because nearly all the data points are well separated, i.e., data from different experimental conditions map to different parts of the feature space, we expect the noise attenuation label and the chromatic dispersion label at an unknown operating point can be estimated through various supervised statistical learning techniques from our training data 122.

Data-Driven Performance Monitoring

We describe various regression procedures 150 that can be applied to the features of our GMMS to monitor the network performance, e.g., the noise attenuation level and the chromatic dispersion level. The regression procedures include linear regression (LR), k nearest neighbors (NN), and locally weighted regression (LWR).

Specifically, we estimate both the noise attenuation level and the chromatic dispersion level, based on the 4-D parameter vector for our GMM.

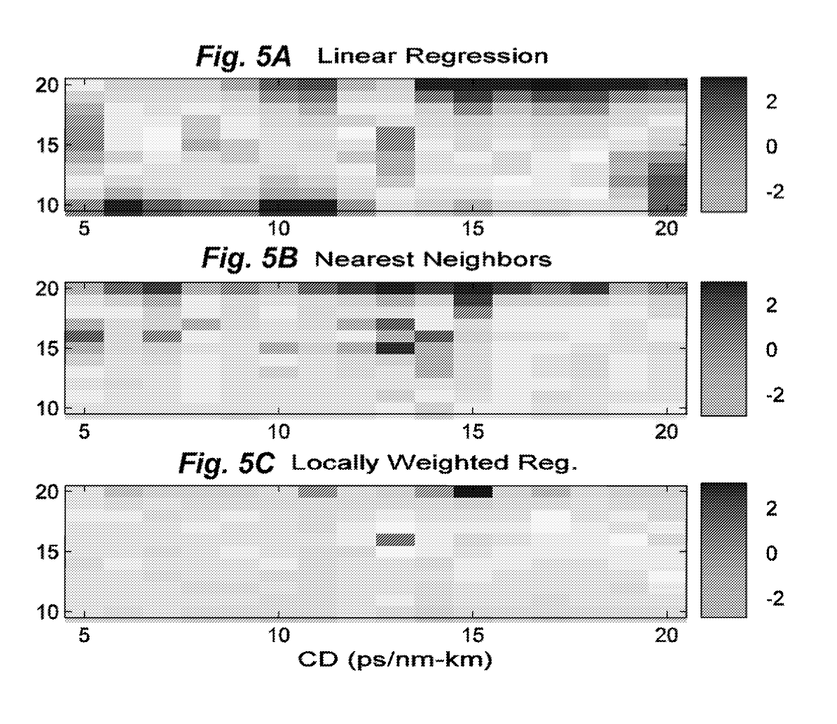

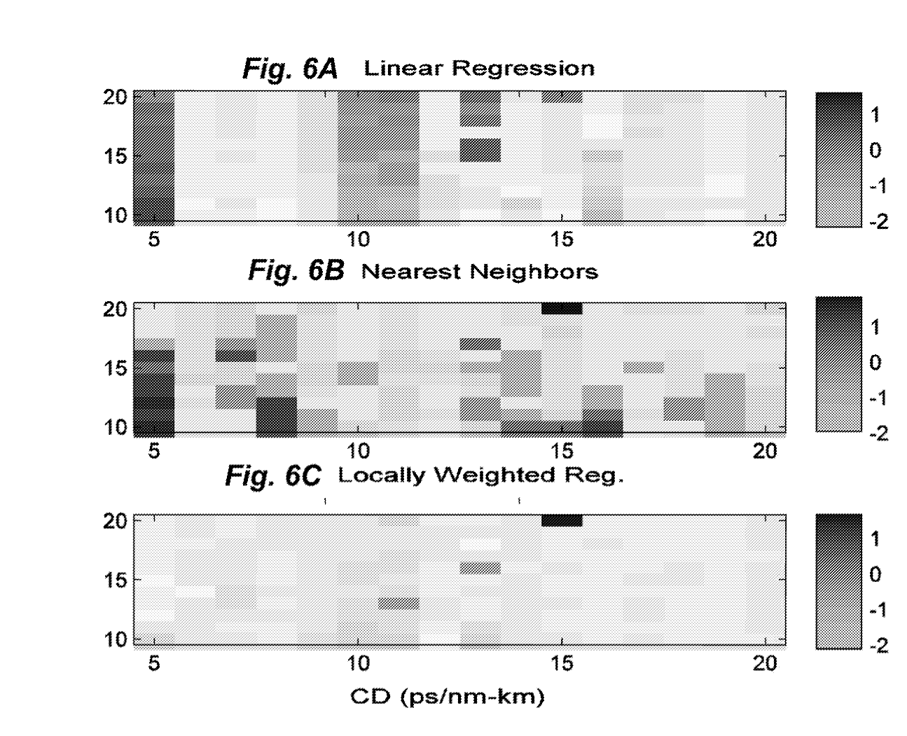

FIGS. 5A-5C and 6A-6C show estimation errors of each technique as a function of the true noise attenuation and CD, respectively. The vertical scale is dB, and the horizontal scale is ps, nm-km. FIG. 5A shows the noise attenuation estimation error for linear regression, FIG. 5B shows nearest neighbors (k=3), and FIG. 5C shows locally weighted regression. The gray scale is in dB.

FIG. 6A shows the chromatic dispersion error for linear regression. FIG. 68 shows the CD for k nearest neighbors (k=3), and FIG. 6C shows locally weighted regression as a function of true network noise attenuation and chromatic dispersion. The gray scale is in ps/nm-km,

Table 1 summarizes these results in terms of root-mean-squared error (RMSE) for k=3 nearest neighbors.

| | Linear Regression | kNN | LWR |
|---|---|---|---|
| Noise Attn (dB) | 1.06 | 0.85 | 0.44 |
| CD (ps/nm-km) | 0.49 | 0.62 | 0.23 |

We focus on the following parameter ranges: 5 to 20 ps/ns-km for the chromatic dispersion level, and 10 to 20 dB for the noise attenuation level.

Training

During training, we use an 8-fold cross-validation for our estimation techniques. In other words, we randomly partition the training data 122 into eight partitions, and estimate the noise attenuation and CD parameters for each partition using an estimator trained on the remaining seven partitions. This helps to avoid overfitting. The training operates essentially as described above, other than the training data are labeled.

Linear Regression

We can apply linear least squares regression to estimate the parameters for the noise attenuation and the CD from the 4-D feature vector (μ₀,μ₁,σ₀,σ₁) 132. We append a column of ones to our feature vectors to allow for a non-zero intercept.

Nearest-Neighbor

In the kNN regression, an estimated output for a feature point is the average of the k nearest neighbors to that feature point in the training dataset. We tried a range of possible values for k. We find that k=3 gives the best results, i.e., smallest error.

To equalize the influence of each of the four dimensions of our feature vectors, we scale each dimension such that it has unit standard deviation before computing the nearest neighbors. Without doing this, a subset of the dimensions could dominate the distance calculation giving less than optimal results.

Locally Weighted Regression

We can also apply locally weighted regression to estimate the noise attenuation and CD parameters. The locally weighted regression technique uses a combination of the linear regression and the kNN. To estimate the output value, linear regression is applied to a weighted subset of the training data that are closest to the query point. As for kNN, we scale each dimension to have unit standard deviation before applying locally weighted regression.

Performance Comparison

We use the root mean square error (RMSE) as a performance metric:

$${ɛ}_{R M S E} = \sqrt{\frac{1}{N} {\sum }_{i = 1}^{N} {( {\hat{δ}}_{i} - {δ}_{i} )}^{2}} , \qquad ( 1 )$$

where N is the number of data points, δᵢ and \hat{δ}ᵢ are the true value and the estimated value for data point i, respectively.

The locally weighted regression outperforms the other techniques for both noise attenuation and CD estimation. All of the techniques perform reasonably well, however, so depending on the desired accuracy for a given situation, any or all of these techniques might be appropriate.

### EFFECT OF THE INVENTION

The invention enables the monitoring of the performance of optical networks. The invention uses a data-driven approach with regression analysis.

It is to be understood that various other adaptations and modifications can be made within the spirit and scope of the invention. Therefore, it is the object of the appended claims to cover all such variations and modifications as come within the true spirit and scope of the invention.

We claim:

1. A method for monitoring a performance of an all-optical network, comprising;
acquiring data in a form of histograms from an optical signal in an all-optical network;
reducing a dimensionality of the histograms by fitting Gaussian mixture models to the histograms to produce corresponding 4-dimensional quadruples (μ₀,μ₁,σ₀,σ₁), wherein μᵢ is a mean, and σᵢ is a standard deviation of each Gaussian mixture model for zero and one bits in the optical as indicated in the subscripts i;
extracting features from the 4-dimensional quadruples; and
applying regression analysis to the features to determine a noise level and a chromatic dispersion level of the optical signal in the all-optical network:.

2. The method of claim 1, wherein the histograms are synchronous.

3. The method of claim 1, wherein the histograms are asynchronous.

4. The method of claim 1, wherein the regression analysis uses a linear regression.

5. The method of claim 1, further comprising:
visualizing the histograms.

6. The method of claim 1, wherein the histograms are normalized.

7. The method of claim 1, wherein the reducing uses a physical network model.

8. The method of claim 1, wherein the reducing uses principal components analysis.

9. The method of claim 1, wherein the regression analysis uses a 2-dimensional projection of the 4-dimensional quadruples to the noise level and chromatic dispersion level.

10. The method of claim 1, further comprising:
training the regression function with training data.

11. The method of claim 1, wherein, the regression analysis uses a k nearest neighbor procedure.

12. The method of claim 1, wherein the regression analysis uses a locally weighted regression.

13. The method of claim 1, wherein the monitoring is passive.

14. The method of claim 8, further comprising:
visualizing first and second components of the principle components analysis.
